(19) United States
(12) Patent Application Publication
(10) Pub. No.: US 2006/0140293 A1
(43) Pub. Date: Jun. 29, 2006

(54) Method for detecting signal and estimating symbol timing

(76) Inventors: Ko-Yin Lai, Nan-Tou Hsien (TW); Wan-Jen Tsai, Hsinchu City (TW); Hung-Jua Ting, Chung-Li City (TW)

Correspondence Address: LIN & ASSOCIATES INTELLECTUAL PROPERTY, P.O. BOX 2339, SARATOGA, CA, 95070-0339, US

(21) Appl. No.: 11/183,214

(22) Filed: Jul. 15, 2005

(30) Foreign Application Priority Data
Dec. 27, 2004 (TW) 093140739

(51) Int. Cl. H04K 1/10; H04L 27/06

(52) U.S. Cl. 375/260; 375/343

(57) ABSTRACT

A method for detecting signal and estimating symbol timing is provided. The method is applicable to the receiver in an OFDM system. The method uses the autocorrelation of the short preamble of input signals to detect signals, and performs the coarse frequency offset compensation at the same time. Then, the end of the short preamble for the input signals is detected by the signal detection. The compensated signals are cross-correlated with the portion of the long preamble or that of guard interval together with the long preamble. In addition, the method uses the information for the end of the short preamble to find out a range of the sliding window for estimating symbol timing. In such a manner, the method can make sure of the accuracy for the symbol timing.

### FIELD OF THE INVENTION

The present invention generally relates to an orthogonal frequency division multiplex (OFDM) signal, and more specifically to a method for OFDM signal detection and symbol timing estimation.

### BACKGROUND OF THE INVENTION

The OFDM technologies can be used in high speed transmission and solving the multi-path interference caused by neighboring symbols. Therefore, OFDM technologies are used in digital audio broadcasting (DAB) and the European standard digital video broadcasting (DVB) system. In addition, OFDM technologies are also the choice of modulation for using in the non-regulated frequency range and the Hiperlan2 of European Telecommunications Standard Institute (ETSI). For example, the highest transmission speed of IEEE 802.11a has reached 54 Mbps.

In the wireless communication system, a receiver must include a signal detection mechanism because the arrival of real system signals is unknown in advance. Signal detection is the first step in the digital baseband receiver. If the transmitted OFDM signal is undetected, the miss of the signal will occur. Thereby, it needs to retransmit the signal. This leads to the additional power consumption and waste of frequency bandwidth. Therefore, a wireless communication system always tries to strengthen the signal detection mechanism in order to reduce signal misses as well as false alarms.

In an OFDM system, a guard interval is added before or after the signal to reduce the multi-path deterioration. When a receiver receives signals, the signals are stripped off the guard interval, transformed from time domain to frequency domain by Fast Fourier Transform (FFT), and recovered to the original signals by a simple divider. Therefore, it is important for an OFDM system to have a signal timing estimation method for finding the correct boundary of an OFDM symbol, and perform time domain/frequency domain transformation.

FIG. 1 shows a schematic view of a conventional OFDM synchronization circuit. Yamamoto, in U.S. Pat. No. 6,646,980, disclosed an OFDM demodulator. As shown in FIG. 1, the signal, after passing an analog-to-digital (A/D) converter 11, is split for performing frequency offset and signal timing estimation simultaneously. In other words, the signal for timing estimation has not passed the coarse frequency compensation, and, therefore, the frequency offset will affect the correctness of timing estimation.

FIG. 2 shows a schematic view of a conventional OFDM timing estimation circuit. As shown in FIG. 2, the structure uses the short preamble to perform cross correlation computation to estimate timing. Without the coarse frequency compensation, the length of cross correlation computation cannot be too long because the reverse vector will appear when the rotation exceeds π, and this reduces the correctness of timing estimation. Yamamoto used the short preamble for timing estimation. But the short preamble is prone to incorrect estimation due to its shortness. However, when a plurality of short preambles (equivalent to the long preamble) is used, a plurality of local maxima will appear, and the ending of the short preambles is unclear. It is also prohibitively time-consuming.

FIG. 3 shows a schematic view of a conventional receiver system of an OFDM packet. Mizoguchi, in U.S. Pat. No. 6,658,063, disclosed a structure for an OFDM packet communication receiver system. As a timing decision circuit 31 shown in FIG. 3 indicates that the system determines the boundary of the symbols based on the three conditions: (1) when the sum C of a plurality of autocorrelations generated by a correlation output filter 32, after a certain delay, exceeds a threshold TH, (2) when C exceeds the threshold TH after another delay, and (3) when C is lower than a pre-defined ratio of the threshold TH. When all the three conditions are met, the value of D is 1, and the OFDM symbol boundary is found.

Mizoguchi used the ending information of the short preamble to improve the correctness of the timing estimation by using the single value of the short preamble as a unit for correlation computation and comparing the value of correlation computation and the threshold TH. However, because a communication system may have many noise interferences and other factors, the system using a single value of the short preamble as the unit may have high probability of signal misses and false alarms.

### SUMMARY OF THE INVENTION

The present invention has been made to overcome the aforementioned drawback of conventional signal detection and timing estimation methods. The primary object of the present invention is to provide a method of signal detection and timing estimation, applicable to a receiver of an OFDM system. The OFDM system uses a communication code frame format. Each transmit frame conforming to the format includes a short preamble, a long preamble, and a plurality of OFDM symbols. The short preamble includes a plurality of short preamble codes with N₁ data points, and the long preamble includes a plurality of long preamble codes with N₂ data points.

The method of signal detection and timing estimation comprises the following steps: (a) computing autocorrelation of the first N₁ points of an input signal; (b) using a signal detection method to determine whether the first N₁ points of the input signal conforming to the short preamble of the frame format; if not, returning to step (a); otherwise, proceeding to step (c); (c) using a short preamble ending determination mechanism to determine whether the first N₁ points of the input signal being completely received; if not, repeating this step; otherwise, proceeding to step (d); and (d) performing coarse frequency compensation on a plurality of specific data points. The step (d) performs the cross correlation computation on the N₁+1 to N₁+N₂ points of the input signal and the long preamble stored at the receiver to find an ending boundary of one of a plurality of known long preambles, to define a sliding window and to find a symbol boundary of the input signal.

The significant feature of the present invention is to use the ending determination mechanism of the short preamble of the input signal to find a sliding window for timing estimation in order to guarantee the correctness of timing estimation. Furthermore, the long preamble, after the coarse frequency compensation, can have a longer preamble code or guard interval plus the long preamble code for cross correlation computation. Because the frequency is coarsely compensated and the length for cross correlation computation is sufficiently long, thereby only taking the sign bit for computation. In such a way, a good computation result can be obtained. Therefore, the present invention uses a signal detection mechanism to ensure the correctness of the long preamble timing estimation. This not only reduces the error rate of the timing estimation, but also finds out the correct boundary of the OFDM symbol easily.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of a conventional OFDM synchronization circuit.

FIG. 2 shows a schematic view of a conventional OFDM timing estimation circuit.

FIG. 3 shows a schematic view of a conventional receiver system of an OFDM packet.

FIG. 4 shows a schematic view of a receiver of an OFDM system.

FIG. 5A shows a method of signal detection and timing estimation according to the present invention.

FIG. 5B shows a signal detection method of the present invention.

FIG. 5C shows a timing estimation method of the present invention.

FIG. 6 shows a frame format of the physical layer convergence procedure (PLCP) of IEEE 802.11a.

FIG. 7 shows the autocorrelation computation of short preambles according to the present invention.

FIG. 8 shows that the present invention uses a sliding window as a unit to compute a first count and a second count, respectively, to determine if the first N₁ points of the input signal are the short preamble of the frame format.

FIG. 9A shows the structure illustrating the timing estimation method of the present invention.

FIG. 9B shows the signal information of FIG. 9A and a schematic view after taking the sign bit.

FIG. 9C shows the signal rₙ, the real and imagery parts of the conjugated complex X_{L-1}* and cross correlation rₙ×X_{L-1}*, after taking the sign bit.

FIG. 10 shows the timing for the data of the input signal, the corresponding autocorrelation (|Cn|²/(Pₙ)²) and cross correlation |yₙ|².

FIG. 11 shows a finite state machine for the signal detection and timing estimation method of the present invention.

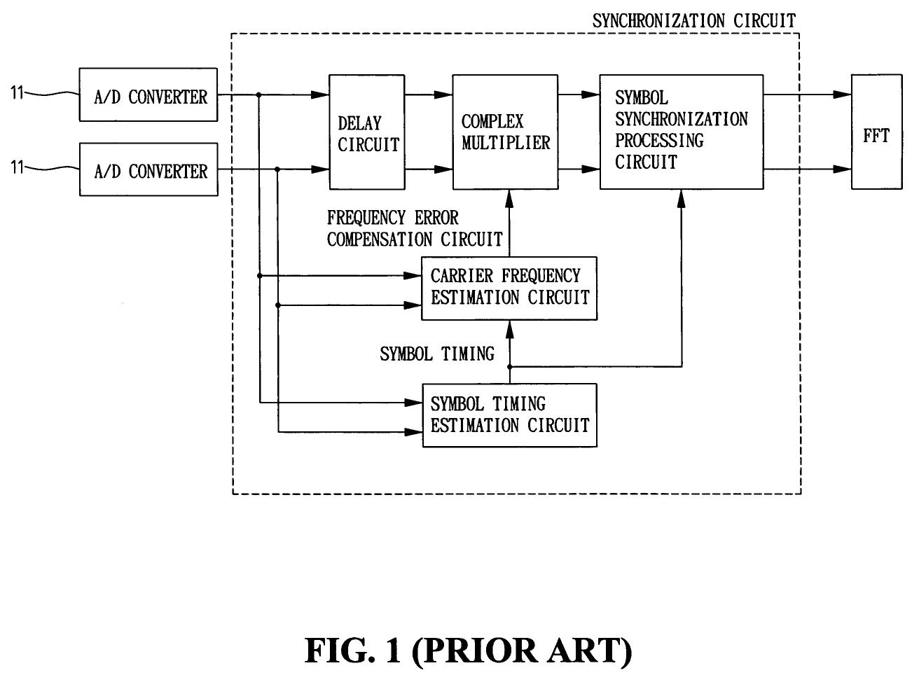

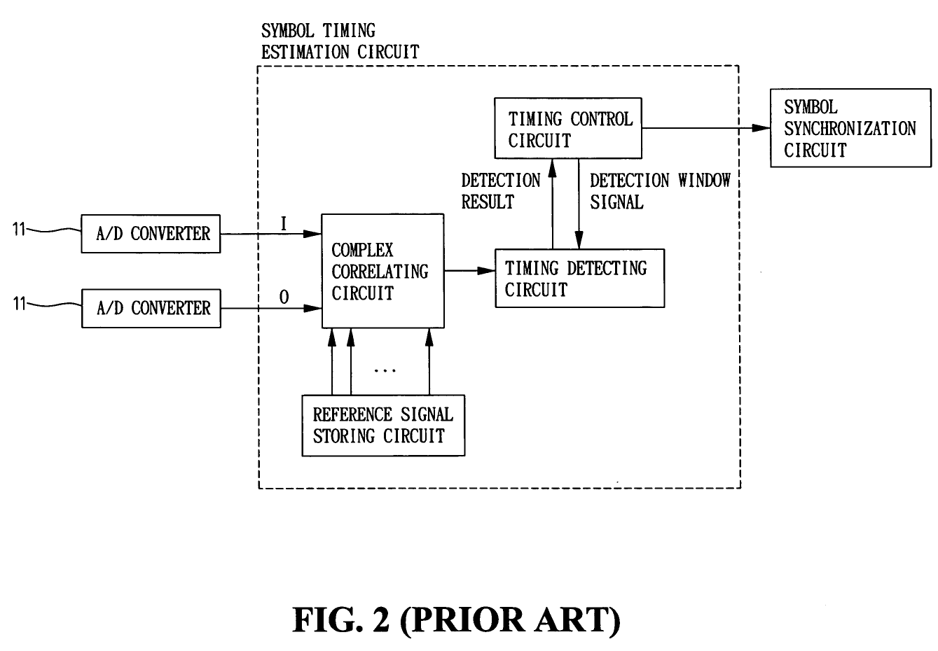

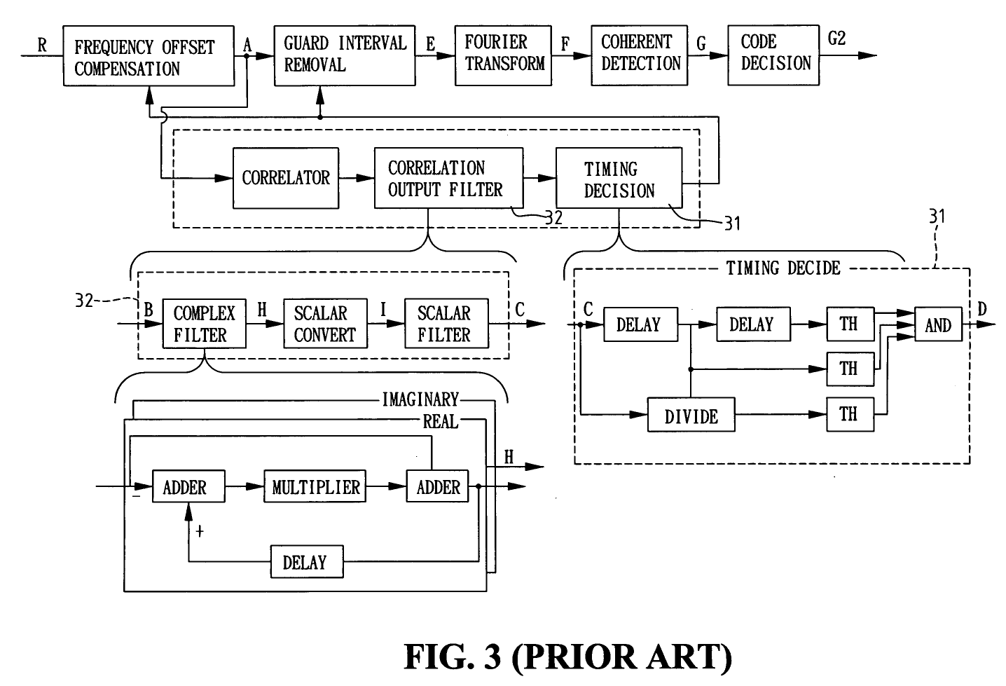

### DETAILED DESCRIPTION OF THE PREFERRED EMBODIMENTS

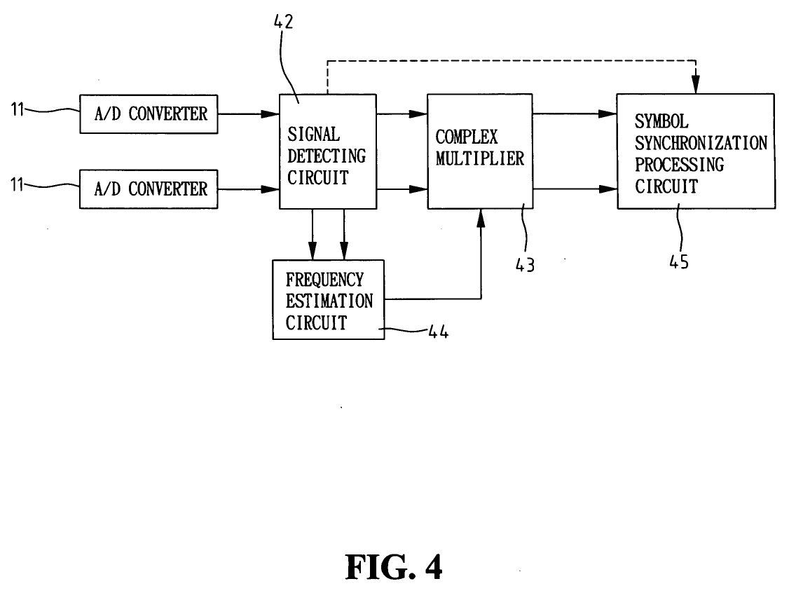

FIG. 4 shows a schematic view of a receiver structure of an OFDM system. Referring to FIG. 4, the receiver comprises two analog-to-digital converters 11, a signal detection circuit 42, a frequency estimation circuit 44, a complex number multiplier 43, and a symbol synchronization processing circuit 45. The signal, after passing A/D converter 11, is split for frequency estimation and signal detection. After the coarse frequency compensation, the timing estimation can be performed so that the subsequent timing estimation can be more correct.

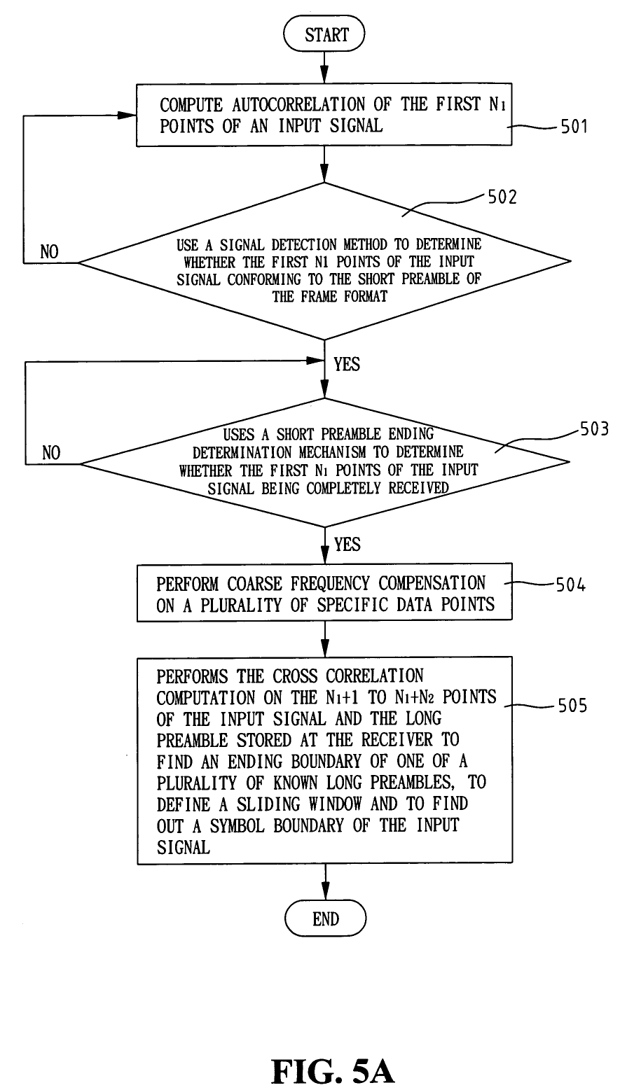

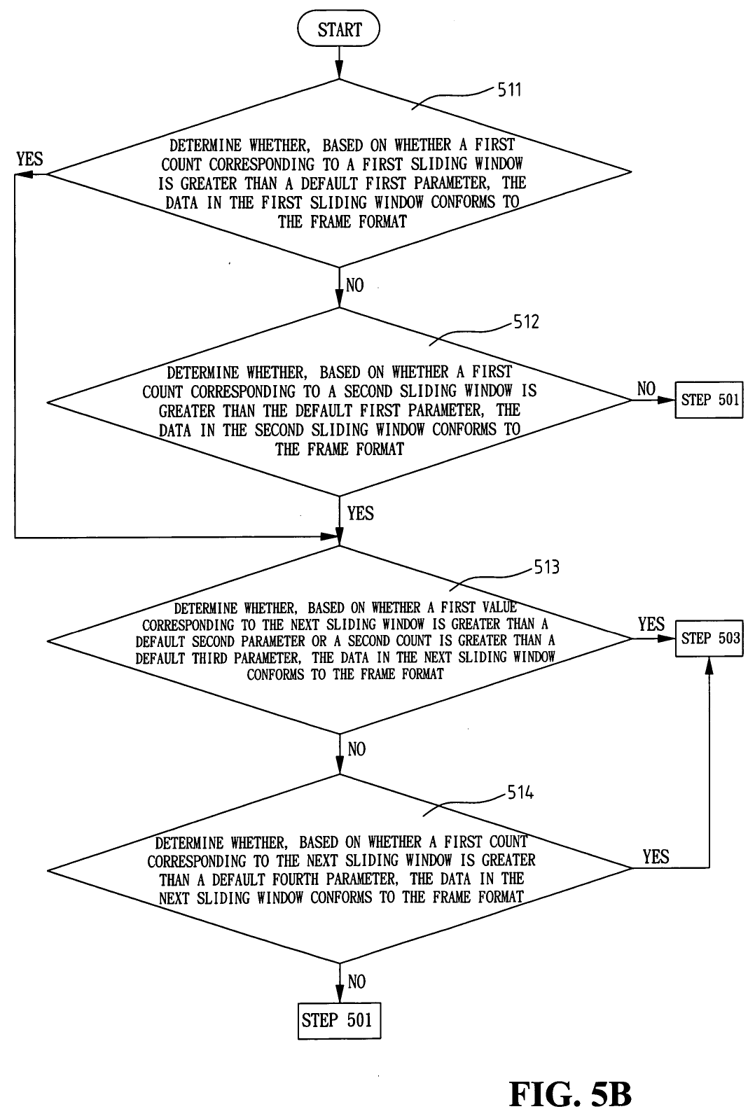

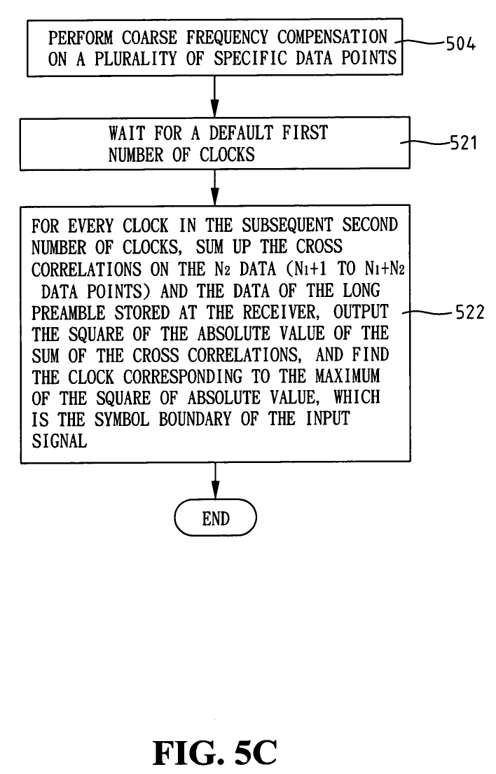

FIG. 5A shows a method of signal detection and timing estimation according to the present invention. As shown in FIG. 5A, the method of signal detection and timing estimation is applicable to a receiver of an OFDM system. The OFDM system uses a communication code frame format. Each transmit frame conforming to the format includes a short preamble, a long preamble, and a plurality of OFDM symbols. The short preamble includes a plurality of short preambles with N₁ data points, and the long preamble includes a plurality of long preamble code with N₂ data points.

The method of signal detection and timing estimation comprises the following steps. Step 501 is to compute autocorrelation of the first N₁ points of an input signal. Step 502 is to use a signal detection method to determine whether the first N₁ points of the input signal conforming to the short preamble of the frame format. If not, return to step 501; otherwise, proceed to step 503. Step 503 uses a short preamble ending determination mechanism to determine whether the first N₁ points of the input signal being completely received. If not, repeat step 503; otherwise, proceed to step 504. Step 504 is to perform coarse frequency compensation on a plurality of specific data points. Finally, step 505 performs the cross correlation computation on the N₁+1 to N₁+N₂ points of the input signal and the long preamble stored at the receiver to find an ending boundary of one of a plurality of known long preambles, to define a sliding window and to find out a symbol boundary of the input signal.

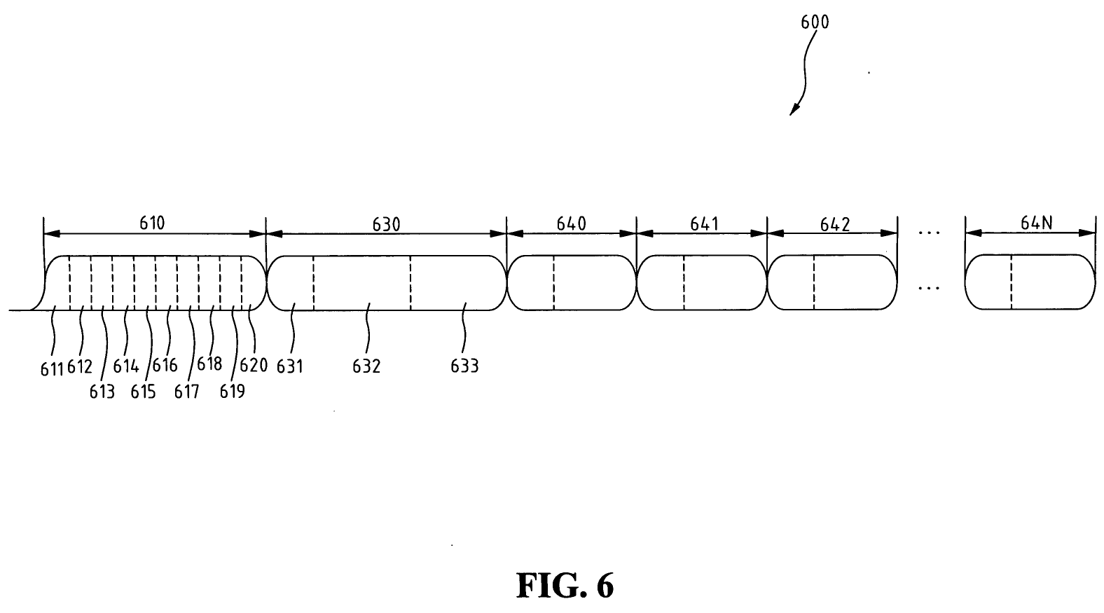

Without loss of generality, the followings use IEEE 802.11a standard to explain the operation of the present invention. FIG. 6 shows a frame format of the physical layer convergence procedure (PLCP) of IEEE 802.11a.

As shown in FIG. 6, the PLCP frame format 600 includes a short preamble 610, a long preamble 630, and a plurality of OFDM symbols 640-64N. According to the PLCP frame format 600, short preamble 610 includes 10 sets of short preamble codes 611-620. Each set of short preamble code includes 16 points of continuous data. The contents of each short preamble code are identical; that is, these 16 points of continuous data repeat 10 times. On the other hand, long preamble 630 includes, in the following order, a protected range 631, and two sets of long preamble codes 632, 633. Each long preamble code includes 64 points of continuous data. The contents of each long preamble code are identical; that is, these 64 points of continuous data repeat twice. The data in protected range 631 is the last 32 points of continuous data of long preamble code 632 or 633. Therefore, for the PLCP frame format 600, N₁=N₂=160 in FIG. 5A.

FIG. 5B shows a signal detection method of the present invention. As shown in FIG. 5B, step 511 is to determine whether, based on whether a first count corresponding to a first sliding window is greater than a default first parameter, the data in the first sliding window conforms to the frame format. If so, go to step 513; otherwise, proceed to step 512. Step 512 is to determine whether, based on whether a first count corresponding to a second sliding window is greater than the default first parameter, the data in the second sliding window conforms to the frame format. If not, return to step 501; otherwise, proceed to step 513. Step 513 is to determine whether, based on whether a first value corresponding to the next sliding window is greater than a default second parameter or a second count is greater than a default third parameter, the data in the next sliding window conforms to the frame format. If so, go to step 503; otherwise, proceed to step 514. Step 514 is to determine whether, based on whether a first count corresponding to the next sliding window is greater than a default fourth parameter, the data in the next sliding window conforms to the frame format. If so, go to step 503; otherwise, proceed to step 501.

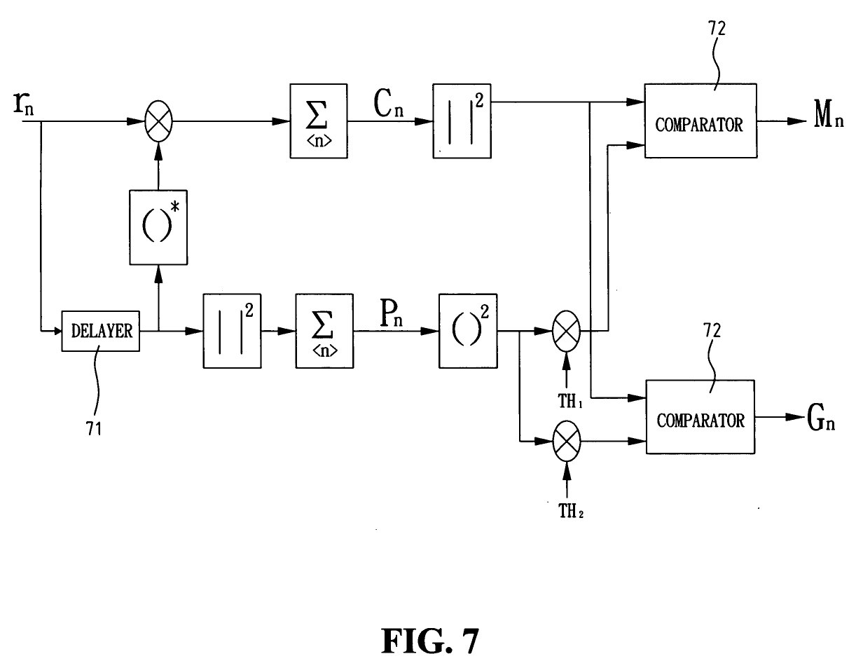

FIG. 7 shows the autocorrelation computation of short preambles according to the present invention. Referring to FIG. 7, the present invention explores the characteristic that the short preamble has a 16-point cycle. For n=16, this invention uses a delayer 71 to delay the data 16 clocks, and Cₙ is the sum of the autocorrelation computation of the 16 pairs of points, each pair is separated by 16 points. Pₙ is the sum of the autocorrelation computation of the signal itself for 16 times. If the signal conforms to the PLCP format, the square of the absolute value of Cₙ will be much greater than Cₙ, which is close to 0 when only noise is present. Using this characteristic, it is possible to determine whether the signal conforms to the PLCP format. However, to avoid the non-ideal effect of the automatic gain control (AGC), the present invention will normalize the signal and then compare the value with a threshold TH. In general, the normalization process requires the use of a divider. Instead, the present invention uses a multiplier to reduce the computation complexity through the following transform:

$$\frac{{\vert {C}_{n} \vert}^{2}}{{( {P}_{n} )}^{2}} \geq TH , {\vert {C}_{n} \vert}^{2} \geq TH \times {( {P}_{n} )}^{2}$$

The square of the Pₙ multiplied by TH implies the normalization of the signal. Therefore, TH can be a constant, and will not be changed by the amplification of the signal.

In FIG. 7, two comparators 72 are used for comparing |Cn|² and TH×(Pₙ)², respectively. When TH is equal to the first threshold TH₁, the upper comparator 72 generates an output Mn. When TH is equal to the second threshold TH₂, the lower comparator 72 generates an output Gn. First threshold TH₁ and second threshold TH₂ will be set to different values according to different communication environment. The range of first threshold TH₁ is about 0.3-0.5, while the second threshold TH₂ is about 0.7-0.8.

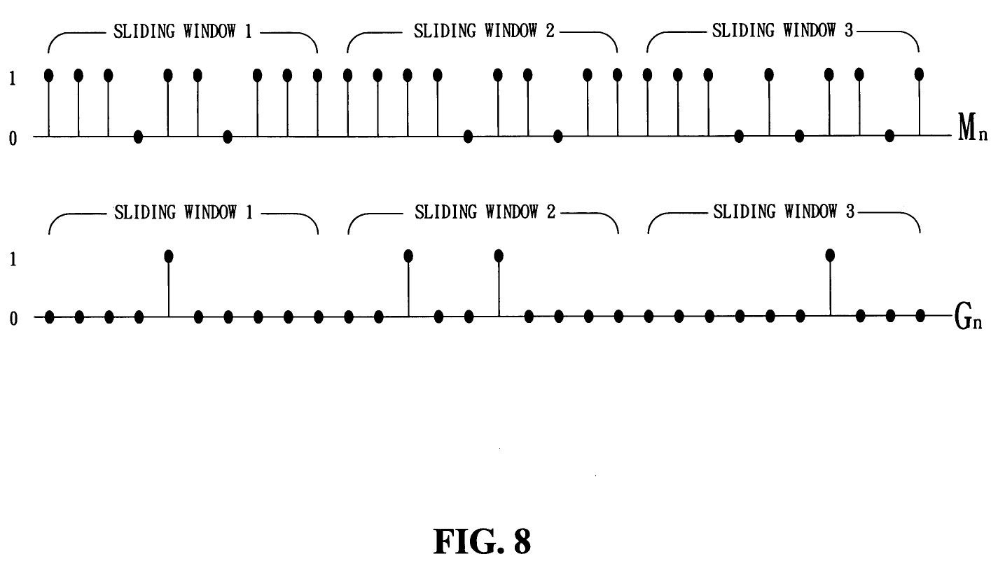

FIG. 8 shows that the present invention uses a sliding window as a unit to compute a first count (the count of Mn=1) and a second count (the count of Gn=1), respectively, to determine if the first N₁ points of the input signal are the short preamble of the frame format. As shown in FIG. 8, the present invention uses the sliding window as a unit. When a certain number of successive sliding windows contain a certain number of |Cn|² greater than TH₁×(Pₙ)² (i.e., the first count), or a certain number of successive sliding windows contain a maximum |Cn|² greater than TH₂×(Pₙ)² (i.e., the second count), it implies that a signal conforms to the short preamble of the PLCP frame format is detected. After detecting the signal conforming to the short preamble of the PLCP frame format, the same algorithm is used to determine the ending of the short preamble. Using the sliding window as a unit, when a sliding window containing a certain number of |Cn|² less than TH₃×(Pₙ)² (i.e., a third count, the count of comparator 72 having Mn=0) is detected, the ending of the short preamble is found, as in Step 503. The third threshold TH₃ is about 0.3-0.4. The length of the sliding window is adjustable, and should be set according to the communication environment.

According to the present invention, after detecting a signal conforming to the short preamble the PLCP frame format and before timing estimation, Cₙ is used for coarse frequency offset estimation, and then a simple complex number multiplier is used to perform coarse frequency compensation on the data following the short preamble of the input signal. According to the present invention, the estimation accuracy can be greatly improved after the input signal is coarsely compensated in the frequency offset.

FIG. 5C shows a timing estimation method of the present invention. As shown in FIG. 5C, step 521 is to wait for a default first number of clocks. Step 522 is, for every clock in the subsequent second number of clocks, to sum up the cross correlations on the N₂ data (N₁+1 to N₁+N₂ data points) and the data of the long preamble stored at the receiver, output the square of the absolute value of the sum of the cross correlations, and find the clock corresponding to the maximum of the square of absolute value, which is the symbol boundary of the input signal.

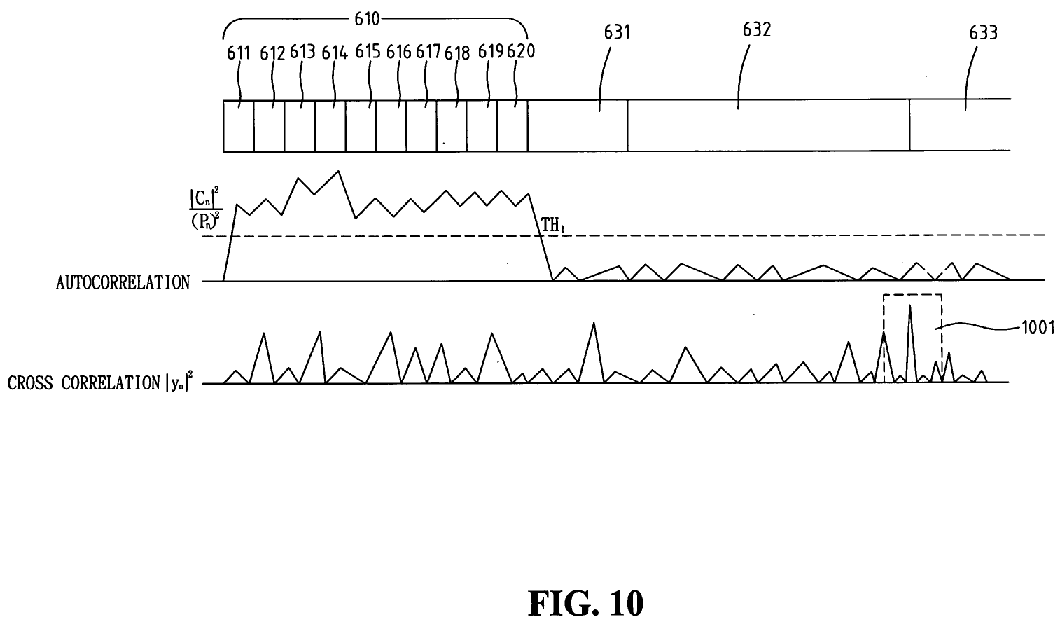

As aforementioned, during the receiving process, the long preamble follows the short preamble. The ending of the long preamble can be roughly estimated when the short preamble ends. At the possible pulse near the long preamble's ending, a sliding window 1001 (will be explained in FIG. 10) can be set up. The sliding window uses the long preamble sign bit of the coarsely compensated input signal and the sign bit of the long preamble stored at the receiver for complex cross correlation computation to find the peak value within the sliding window 1001. This is the boundary of the OFDM symbol.

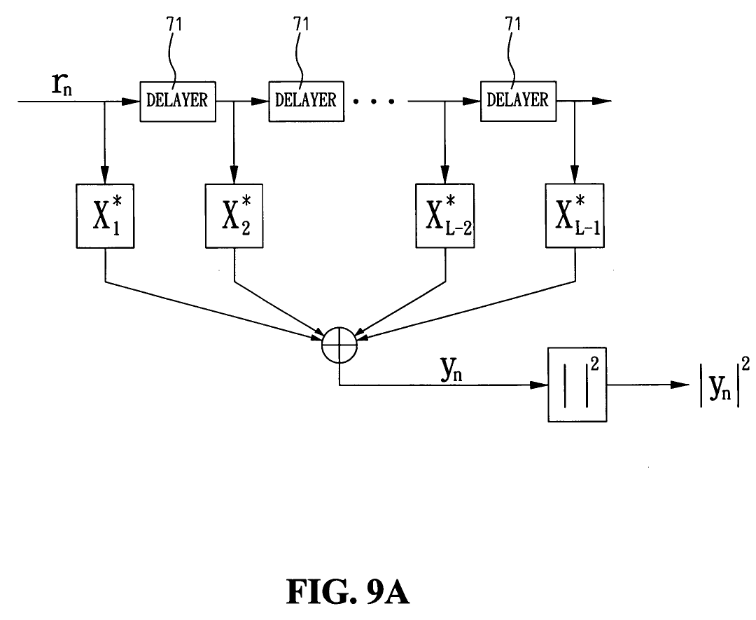

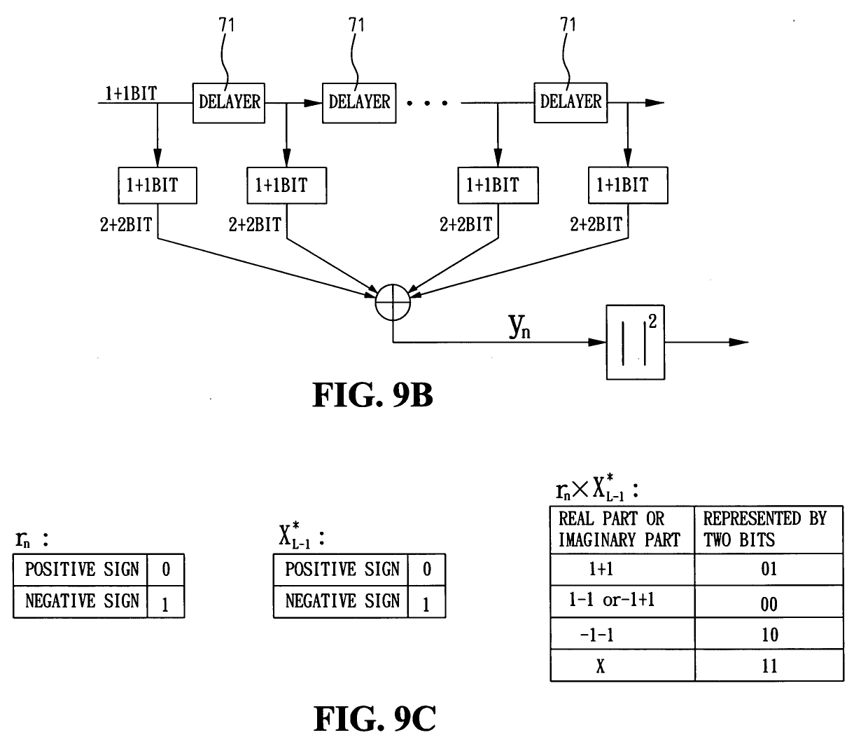

FIG. 9A shows the structure illustrating the timing estimation method of the present invention. FIG. 9B shows the signal information of FIG. 9A and a schematic view after taking the sign bit. FIG. 9C shows the signal rₙ, the real and imagery parts of the conjugated complex X_{L-1}* and cross correlation rₙ×X_{L-1}*, after taking the sign bit.

As shown in FIG. 9A, using L=64 as an example, the input signal rₙ delayed by several delayers 71 (each delays a clock), is multiplied by the conjugated complex X_{L-1} * of the long preamble stored at the receiver. The sum of all the 64 multiplications will yield yₙ. The number shown in FIG. 9B is the expression of the signal rₙ and the conjugated complex X_{L-1} * of the long preamble of FIG. 9A after taking the sign bit. In FIG. 9C, the positive sign bit of rₙ and X_{L-1}* are expressed as 0, and the negative sign bit of rₙ and X_{L-1}* are expressed as 1. For example, representing rₙ as a+bj, X*_{L-1} as c+dj, and rₙ×X*_{L-1} as e+fj, the following equation can be obtained.
e=ac−bd=1+1=2 (if ac>0, bd<0)
or e=1−=0 (if ac>0, bd>0)
or e=−1+1=0 (if ac<0, bd<0)
or e=−1−1=−2 (if ac<0, bd>0)
where ac and bd both use the sign bits. Because there are three possible results for the real part e, it requires two bits to represent. Similarly, there are also three possible results for imagery part f=(ad+bc), it also requires two bits. Therefore, the results of rₙ×X_{L-1}* require four bits for representation.

FIG. 10 shows the timing for the data of the input signal, the corresponding autocorrelation (|Cn|²/(Pₙ)²) and cross correlation |yₙ|². As shown in FIG. 10, the corresponding autocorrelation (|Cn|²/(Pₙ)²) is greater than first threshold TH₁ during receiving the short preamble of the input signal. When short preamble 610 of the input signal ends, the corresponding autocorrelation (|Cn|²/(Pₙ)²) starts to drop to far less than first threshold TH₁. Cross correlation |yₙ|² is always low during the receiving of short preamble 610, guard interval 631 and the first long preamble code 632. However, when a sliding window 1001 is set around the boundary of the first long preamble code 632 and the second long preamble code 632, a peak of corresponding cross correlation |yₙ|² within sliding window 1001 can be observed. The peak occurs at the boundary of the first long preamble code 632 and the second long preamble code 633.

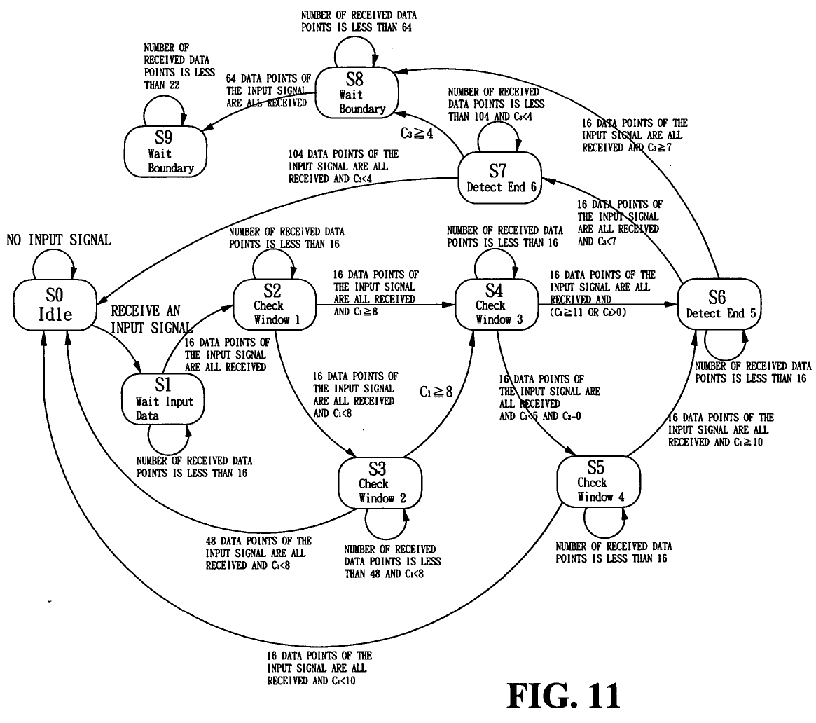

The signal detection and timing estimation method of the present invention can be expressed with a finite state machine (FSM). As shown in FIG. 11, the state machine includes 10 states, categorized in three groups, i.e. signal detection state, testing short preamble ending state, and testing symbol boundary state. The following describes the 10 states using operating frequency 20 MHz, sliding window=16 samples, and PLCP frame format as example.

(a) Signal detection state: for testing whether the input signal conforms to the PLCP frame format, including the following six states:

(S0) Idle: the initial state. When it is at the receiver end, the FSM will transit to the Wait Input Data state on the next pulse.

(S1) Wait Input Data: the state for waiting for the input data. When the first 16 data points of the input signal for autocorrelation computation are all received, the FSM transits to Check Window 1 state.

(S2) Check Window 1: a state for checking the pattern of the input signal, and receiving the next 16 data points for autocorrelation computation. When the first threshold TH₁=0.5, and all the 16 data points for Window1 are all received and autocorrelation computed, the first count C1 of Window1 (i.e., the count of Mn=1) is checked. If C1 is greater than 8 (the default first parameter), the FSM transits to Check Window 3 state; otherwise, it transits to Check Window 2 state.

(S3) Check Window 2: another state for checking the input signal and receiving the next 48 data points for autocorrelation computation. During the receiving process, when C1 of Window 2 exceeds 8, the FSM transits to Check Window 3; otherwise, it returns to Idle state.

(S4) Check Window 3: another state for checking the input signal and receiving the next 16 data points for autocorrelation computation. Under the condition that first threshold TH₁=0.5 and second threshold TH₂=0.75, when all the 16 data points for Window 3 are all received and autocorrelation computed, the first count C1 of Window3 (i.e., the count of Mn=1) and the second count C2 (i.e., the count of Gn=1) are checked. If C1 is greater than 11 (the default second parameter) or C2 is greater than 1 (the default third parameter), the FSM transits to Detect Data End state; otherwise, it transits to Check Window4 state.

(S5) Check Window 4: yet another state for checking the input signal and receiving the next 16 data points for autocorrelation computation. During the receiving process, when C1 of Window 4 exceeds 10 (the default fourth parameter), the FSM transits to Detect Data End 5 state; otherwise, it returns to Idle state.

(b) Testing short preamble ending state: for detecting the ending of the short preamble of the input signal, including the following two states:

(S6) Detect Data End 5: a state for detecting the ending of short preamble and receiving the next 16 data points for autocorrelation computation. Under the condition that third threshold TH₃=0.3438, when all the 16 data points for Window 6 are all received and autocorrelation computed, the first count C3 of Window 6 (i.e., the count of Mn=0). If C3 is greater than 7 (the default fifth parameter), the FSM transits to Wait Boundary state; otherwise, it transits to Detect Data End 6 state.

(S7) Detect Data End 6: another state for detecting the ending of data and receiving the next 104 data points for autocorrelation computation. During the receiving process, when C3 of Window6 exceeds 7 (the default fifth parameter), the FSM transits to Wait Boundary state; otherwise, it returns to Idle state.

(c) Testing symbol boundary state: for finding OFDM symbol boundary, including the following two states:

(S8) Wait Boundary: a state for waiting for the long preamble boundary. After detecting the ending of the short preamble of the input signal, the state starts to receive the next 64 data points of the input signal (i.e., the default first number of pulses=64) for cross correlation computation. When all the 64 points are received, the FSM transits to Detect Boundary state.

(S9) Detect Boundary: a state for finding OFDM symbol boundary and receiving the next 22 data points of the input signal (i.e., the default second number of the pulses=22) for cross correlation computation with the long preamble at the receiver. The max peak value among the 22 cross correlation computations is the OFDM symbol boundary.

In summary, the present invention uses a sliding window as a unit and the ending detection mechanism of the short preamble of the input signal to find a sliding window for timing estimation in order to guarantee the correctness of timing estimation. Furthermore, the long preamble, after the coarse frequency compensation, can have a longer preamble code or guard interval plus the long preamble code for cross correlation computation. Because the frequency is coarsely compensated and the length for cross correlation computation is sufficiently long, only the sign bit is required for obtaining a good performance result. Therefore, the present invention uses a Detect Data End mechanism to ensure the correctness of the long preamble timing estimation. This not only reduces the error rate of the timing estimation, but is also able to find the correct boundary of the OFDM symbol easily.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of signal detection and timing estimation, applied to a receiver of an orthogonal frequency division multiplex (OFDM) system, said OFDM system using a communication code frame format, each input signal conforming to said format comprising a short preamble, a long preamble, and a plurality of OFDM symbols, said short preamble comprising a plurality of short preambles with N₁ data points, and said long preamble comprising a plurality of long preamble codes with N₂ data points, said method comprising the steps of:
(a) computing autocorrelation of said first N₁ points of an input signal;
(b) using a signal detection method to determine whether said first N₁ points of said input signal conforming to said short preamble of said frame format; if not, returning to step (a); otherwise, proceeding to step (c);
(c) using a short preamble ending detection mechanism to determine whether said first N₁ points of said input signal being completely received; if not, repeating step
(c); otherwise, proceeding to step (d);
(d) performing coarse frequency compensation on a plurality of specific data points; and
(e) performing the cross correlation computation on said N₁+1 to N₁+N₂ points of said input signal and said long preamble stored at said receiver to find an ending boundary of one of a plurality of known long preambles, to define a sliding window and to find out a symbol boundary of the input signal.

2. The method as claimed in claim 1, wherein said step (a) further comprises the step of:
during each clock, summing the autocorrelation results of data points prior to and following a part of the first N₁ data points of said input signal and outputting a first autocorrelation value, and during each, summing the autocorrelation results of data points said part of the first N₁ data points of said input signal and outputting a second auto correlation.

3. The method as claimed in claim 2, wherein said signal detection method of said step (b) uses a first count and a second count, and at least two sliding windows to detect whether the first N₁ data points of said input signal conform to said short preamble of said frame format.

4. The method as claimed in claim 3, wherein said signal detection method of said step (b) further comprises the steps of:
(b1) determining whether, based on whether a first value corresponding to a first sliding window being greater than a default first parameter, the data in said first sliding window conforming to said frame format, if so, going to step (b3); otherwise, proceeding to step (b2);
(b2) determining whether, based on whether a first value corresponding to a second sliding window being greater than said default first parameter, the data in said second sliding window conforming to said frame format; if not, returning to step (a); otherwise, proceeding to step (b3);
(b3) determining whether, based on whether a first count corresponding to a next sliding window being greater than a default second parameter or a second count being greater than a default third parameter, the data in said next sliding window conforming to said frame format; if so, going to step (c), otherwise, proceeding to step (b4); and
(b4) determining whether, based on whether a first value corresponding to a next sliding window being greater than a default fourth parameter, the data in said next sliding window conforming to the frame format; if so, going to step (c), otherwise, returning to step (a).

5. The method as claimed in claim 4, wherein said first count at said step (b) is the count of the times when said first autocorrelation value is greater than a first threshold multiplied by said second autocorrelation value in corresponding said sliding window.

6. The method as claimed in claim 4, wherein said second count at said step (b) is the count of the times when said first autocorrelation value is greater than a second threshold multiplied by said second autocorrelation value in corresponding said sliding window.

7. The method as claimed in claim 3, wherein the length of said sliding window at said step (b) is adjustable.

8. The method as claimed in claim 4, wherein said default first parameter, said default second parameter, said default third parameter and said default fourth parameter of said step (b) are adjustable.

9. The method as claimed in claim 5, wherein the range of said first threshold is adjustable.

10. The method as claimed in claim 6, wherein the range of said second threshold is adjustable.

11. The method as claimed in claim 4, wherein said method for detecting said short preamble ending is based on whether a third value corresponding to the next sliding window is greater than a default fifth parameter.

12. The method as claimed in claim 11, wherein said third parameter is the count of times when said first autocorrelation value is less than a third threshold multiplied by said second autocorrelation value within said next sliding window.

13. The method as claimed in claim 12, wherein the range of said third threshold is adjustable.

14. The method as claimed in claim 4, wherein said default fifth parameter of said step (b) is adjustable.

15. The method as claimed in claim 1, wherein said step (e) further comprises the steps of:
(e1) waiting for a default first number of clocks; and
(e2) within each clock of a default second number of clocks, summing a part of data of N1+1 and N1+N2 data points of said input signal, performing cross correlation on said part and long preamble stored at said receiver, outputting the square of a absolute value of cross correlation, and finding out the clock corresponding to the maximum among said square of the absolute value of cross correlation.

16. The method as claimed in claim 15, wherein said default first number of clocks and said default second number of clocks are adjustable.

17. The method as claimed in claim 15, wherein said plurality of specific data are the N₁+1 to N₁+N₂ data points of said input signal for cross correlation computation.
